(19) United States
(12) Patent Application Publication
(10) Pub. No.: US 2005/0044661 A1
(43) Pub. Date: Mar. 3, 2005

(54) Door-closing device using a cam

(75) Inventor: Chul-Soo Cho, Dongnae-gu (KR)

Correspondence Address: Peter F. Corless;EDWARDS & ANGELL, LLP, P.O. Box 55874, Boston, MA, 02205, US

(73) Assignee: Sojin Corporation

(21) Appl. No.: 10/903,033

(22) Filed: Jul. 30, 2004

(30) Foreign Application Priority Data
Aug. 29, 2003 (KR) 2003-60291

(51) Int. Cl. E05F 1/08

(52) U.S. Cl. 16/76

(57) ABSTRACT

The present invention relates to a door-closing device with using a cam. In particular, the present invention relates to the door-closing device restoring a door automatically to an original position with using the restoring force of a spring which is generated by the cam, wherein the cam converts rotational movement to rectilinear movement after the door is pushed and opened. The door-closing device according to the present invention includes a shaft having a fixed part formed on one end of the shaft and fixed to the door frame to prevent rotation, a sliding part whose outer circumferential surface is partly planar on the other end of the shaft, and a supporting part protruded on the outer circumferential surface of the shaft between the fixed part and the sliding part; a housing fixed to the door, having a shaft hole formed on one end of the housing for the shaft to be inserted to the inside, wherein the inner part connected to the shaft hole is cylindrically spaced; a cam fixed to the other end of the housing, having an annular guide surface protruded into the inner part of the housing; a guide having a circular plate with a through hole of corresponding shape to the cross-section of the sliding part penetrating the through hole in the center of the circular plate, and a key protruded from the circular plate, moving along the guide surface of the cam, wherein the outer circumferential surface of the circular plate rectilinearly moves with contacting the surface of the inner part of the housing; and a compression spring set up to wrap up the shaft between the supporting part of the shaft and the circular plate of the guide.

### CROSS-REFERENCE TO RELATED APPLICATIONS

This application claims priority from Korean Patent Application No. 2003-60291, filed on Aug. 29, 2003, the contents of which are incorporated herein for reference in their entirety.

### BACKGROUND OF THE INVENTION

1. Field of the Invention

The present invention relates to a door-closing device using a cam. In particular, the present invention relates to the door-closing device restoring a door automatically to an original position with using the restoring force of a spring which is generated by the cam, wherein the cam converts rotational movement to rectilinear movement after the door is pushed and opened.

2. Description of the Related Art

Conventional door-closing devices are classified into a rectilinear operation type and a rotational operation type. The rectilinear operation type moves the door by rotating the shaft of a pinion. Thus, the rectilinear operation type has several problems: the places to set up are restricted, noises are made when it is used for a long period of time, a bearing supporting the shaft of the pinion is easily worn off, and uneven wear is made on piston and cylinder.

Also, the rotational operation type divides an operating room into two parts by a pair of protrusions. So, the rotational operation type restricts the rotational angle of the shaft within 90°. Thus, the rotational operation type is hard to be applied in various places because a restoring spring should be supported between the inside and outside, which makes the size larger. Further, the structure is complicated, and so the rotational operation type frequently breaks down and has low productivity.

### SUMMARY OF THE INVENTION

The object of the present invention is to provide a door-closing device which can automatically close an open door by the cam and spring, and whose closing velocity can be controlled by the user.

The door-closing device according to one embodiment of the present invention includes a shaft having a fixed part formed on one end of the shaft and fixed to the door frame to prevent rotation, a sliding part whose outer circumferential surface is partly planar on the other end of the shaft, and a supporting part protruded on the outer circumferential surface of the shaft between the fixed part and the sliding part; a housing fixed to the door, having a shaft hole formed on one end of the housing for the shaft to be inserted to the inside, wherein the inner part connected to the shaft hole is cylindrically spaced; a cam fixed to the other end of the housing, having an annular guide surface protruded into the inner part of the housing; a guide having a circular plate with a through hole of corresponding shape to the cross-section of the sliding part penetrating the through hole in the center of the circular plate, and a key protruded from the circular plate, moving along the guide surface of the cam, wherein the outer circumferential surface of the circular plate rectilinearly moves with contacting the surface of the inner part of the housing; and a compression spring set up to wrap up the shaft between the supporting part of the shaft and the circular plate of the guide.

It is desirable for the guide to include a first fluid passage and a second fluid passage penetrating the circular plate; and a check valve plate for opening the second fluid passage by the flow of viscous fluid filled in the inner part of the housing when the compression spring is compressed, wherein one end of the check valve plate is fixed to the surface of the circular plate opposite to the cam, and the other end of the check valve plate is set up to close the second fluid passage.

It is desirable for the door-closing device to further include a door frame bracket wherein the fixed part is inserted into a fixing hole formed on one end of the door frame bracket, and fixed, and the other end of the door frame bracket is fixed to the door frame; and a door bracket wherein one end is fixed to the housing, and the other end is fixed to the door.

It is desirable for the cam to have upward parts and key grooves subsequently formed on the guide surface.

It is desirable for the door-closing device to further include a connecting part extruded from the other end of the shaft to penetrate the center of the cam; a cover fixed to the housing to contain the connecting part protruded to the outside of the housing in the inner part of the cover; a control part set up inside of the cover to face the connecting part; and a torsion spring of which each end is connected to the connecting part and the control part.

It is desirable for the control part to include a fixed gear part fixed to the cover, with fixed gears arranged by the direction of the circumference around a wrench hole formed in the center of the fixed gear part; and a control plate having the first two arm fixing parts protruded to form space fixing the first arm of the torsion spring on one surface of the control plate, and control plate gears corresponding to the fixed gears around a wrench groove formed in the center of the control plate on the other surface of the control plate, wherein the control plate gears are arranged by the direction of the circumference.

It is desirable for the connecting part to have the second two arm fixing parts protruded to form space fixing the second arm of the torsion spring.

The door-closing device according to the present invention is effective for automatically closing the door by the restoring force generated from changing the rotation for opening the door into compression and torsion of the spring with using the cam, and controlling the closing velocity according to set-up conditions by making the user easily control the restoring force of the spring from the outside.

### BRIEF DESCRIPTION OF THE DRAWINGS

The above and other features and advantages of the present invention will be more clearly understood from the following detailed description taken in conjunction with the accompanying drawings.

FIG. 1 is a perspective view of the door-closing device according to a preferred embodiment of the present invention.

FIG. 2 is a partially sectional view of the door-closing device according to a preferred embodiment of the present invention.

FIG. 3 is a partially sectional view briefly showing the door-closing device of FIG. 2.

FIG. 4 is an exploded schematic view of the door-closing device according to a preferred embodiment of the present invention.

FIG. 5 is a view briefly showing the door-closing device set up according to a preferred embodiment of the present invention.

### DESCRIPTION OF EMBODIMENTS

Hereinafter, a preferred embodiment of the present invention will be explained in more detail with reference to the accompanying drawings.

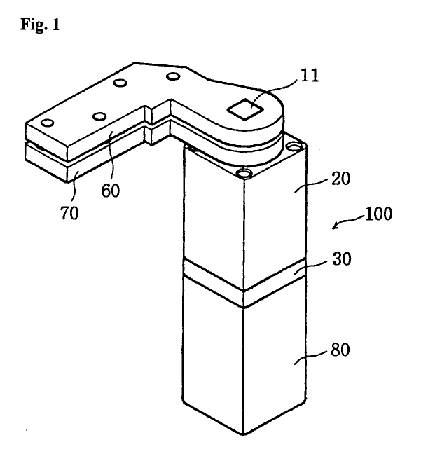

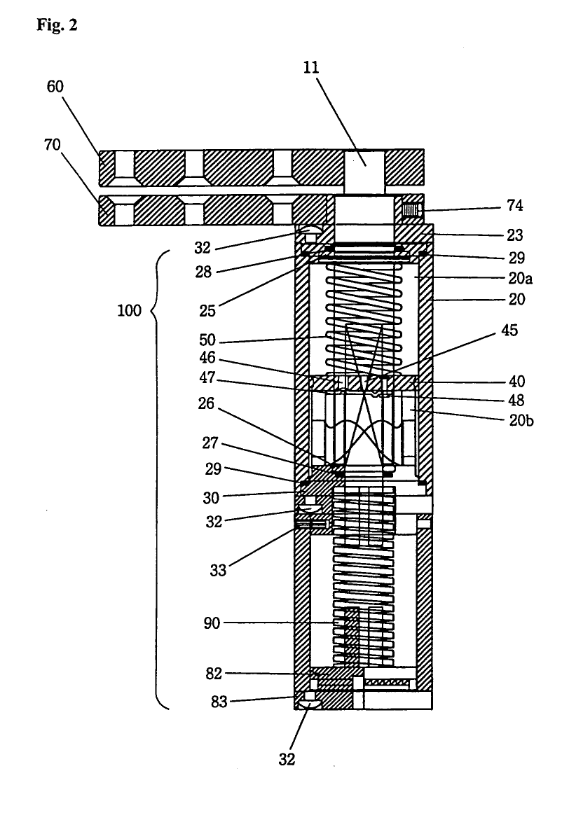

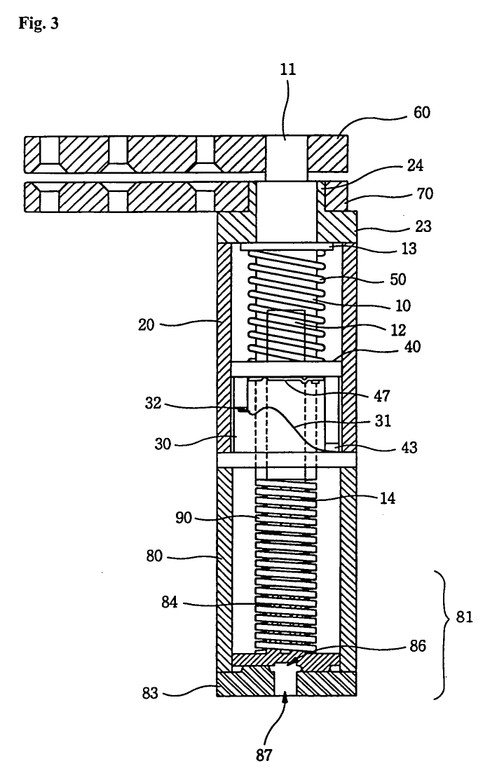

FIG. 1 to FIG. 4 is a perspective view, partially sectional view, partially brief sectional view, and exploded schematic view, of the door-closing device according to a preferred embodiment of the present invention, respectively.

The door-closing device according to a preferred embodiment of the present invention includes a body 100 having a housing 20, a cam 30, and a cover 80, in sequence, a door frame bracket 60, and a door bracket 70.

The housing 20 includes a shaft 10, the cam 30, a guide 40, and a compression spring 50. The cover 80 fixed to the cam 30 includes a connecting part 14, a control part 81, and a torsion spring 90.

The housing 20 is fixed to the door. Cylindrical space 21 penetrated by the shaft 10 is formed inside from one end to the other end of the housing 20.

The shaft 10 is a cylindrical axis inserted into the housing 20. The shaft 10 includes a fixed part 11, a sliding part 12, and a supporting part 13.

The fixed part 11 with the shape of square column is formed on the upper part of the shaft 10. The sliding part 12 is a planar part on the outer circumferential surface of the shaft 10, and is formed from the lower end of the shaft 10 to a determined height. The supporting part 13 is a protruded part along the outer circumferential surface between the fixed part 11 and the sliding part 12.

After the shaft 10 is inserted into the inside of the housing 20, the shaft 10 is prevented from being separated to the inserted direction by combining an upper cap 23 with the housing 20. A fixed part 24 for the door bracket with the shape of square column is formed on the upper cap 23 in order for the door bracket 70 to be fixed, and also a through hole 24a of smaller diameter than the supporting part 13 is formed in the center of the fixed part 24. On the other hand, it is preferable that an upper bush 25 is provided between the upper cap 23 and the housing 20, with o-rings 28 and 29.

The cam 30 is fixed to the lower part of the housing 20. An annular guide surface 31 with certain thickness is protruded into the inner part of the housing 20, and upward parts and key grooves 32 are subsequently formed on the annular guide surface 31. A through hole is formed in the center of the cam 30, and the shaft 10 passes through the through hole. It is preferable that a lower bush 26 and an o-ring 27 are provided in order to minimize oil-leak and friction by rotation between the shaft 10 and cam 30.

The guide 40 comprises a circular plate 41 and a key 43 protruded downward. The inner part of the housing 20 is divided into an upper compartment 20a and a lower compartment 20b by the circular plate 41 circumscribing to the inner circumferential surface 22 of the housing 20. Each compartment, 20a, 20b is filled with viscous fluid to function as damping.

A through hole 42 passed through by the sliding part 12 of the shaft 10 is formed in the center of the circular plate 41, wherein the through hole 42 has the corresponding shape to the cross-section of the sliding part 12. In addition, a first fluid passage 45 and a second fluid passage 46 penetrating the circular plate 41 are formed on the circular plate 41. A check valve plate 47 is set up at the lower hole of the second fluid passage 46. One end of the check valve plate 47 is fixed to the lower surface of the circular plate 41 by a pin 48, and the other end of the check valve plate 47 is set up to close the second fluid passage 46. It is preferable that the circular plate 41 is coated by the injection molding method in order to minimize the friction between the housing 20 and the shaft 10.

The key 43 contacts the guide surface 31 of the cam 30 and makes the circular plate 41 circumscribing the inner circular surface 22 of the housing 20 move upward and downward along the sliding part 12 according to the height variation by the circumferential direction of the guide surface 31. It is preferable that the key 43 is heat-treated.

The compression spring 50 is positioned to wrap up the shaft 10 between the supporting part 13 of the shaft 10 and the circular plate 41 of the guide 40.

The cover 80, whose inner part is cylindrically spaced, is mounted on the lower part of the cam 30.

A connecting part 14 is formed on the end of the shaft 10 penetrating the cam 30, and in the center, space is formed by the second two arm fixing parts 15 protruded to fix the second arm 92 of the torsion spring 90.

A control part 81 is provided at the lower part of the cover 80, and comprises a fixed gear part 83 and a control plate 82.

The fixed gear part 83 is fixed to close the lower part of the cover 80, and a wrench hole 87 for the wrench to pass through is formed in the center of the fixed gear part 83. Fixed gears 88 are arranged around the wrench hole 87 by the direction of the circumference on the upper surface of the fixed gear part 83.

The control plate 82 is a circular plate, and circumscribes the inner circumferential surface formed in the inner space of the cover 80. The first two arm fixing parts 84 are formed by protrusion on the upper surface of the control plate 82 to form space that the first arm 91 of the torsion spring 90 is fixed. A wrench groove 86 is formed in the center of the lower surface, and control plate gears 85 are arranged around the wrench groove 86 by the direction of the circumference. The control plate gears 85 are correspondingly engaged with the fixed gears 88 of the fixed gear part 83.

The first arm 91 of the torsion spring 90 is connected to the connecting part 14 by the first arm fixing part 84. The second arm 92 is connected to the control part 81 by the second arm fixing part 15. The first arm fixing part 84 and the second arm fixing part 15 prevent bending of the torsion spring 90 at its torsion.

The door frame bracket 60 and the door bracket 70 to make setting up of the door and door frame easy are mounted on the upper part of the body 100.

The fixed part 11 of the shaft 10 is inserted into a fixing hole 61 formed on one end of the door frame bracket 60 and fixed. And, bolt holes 63 are formed on the other end of the door frame bracket 60 to fix the upper surface 62 to the door frame.

The fixed part 24 for the door bracket 70 is inserted into a fixing hole 71 formed on one end of the door bracket 70 and fixed. And, bolt holes 73 are formed on the other end of the door bracket 70 to fix the lower surface 72 to the door.

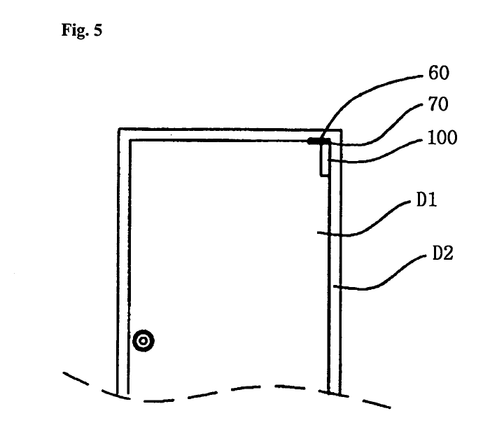

Hereinafter, the method of closing door with using the door-closing device according to a preferred embodiment of the present invention will be described with referring to FIGS. 1 to 5. FIG. 5 is a view briefly showing the door-closing device set up to a door according to the preferred embodiment of the present invention.

The upper surface 62 of the door frame bracket 60 is fixed to the lower surface of the door frame D2 by bolts. The shaft 10 is fixed by the fixing hole 61 to prevent rotation of the shaft 10.

The lower surface 72 of the door bracket 70 is fixed to the upper surface of the door D1 by bolts. The body 100 is fixed by the fixing hole 71. Thus, according to rotation of the door, both the door bracket 70 and the body 100 rotate together around the shaft 10 fixed to the door frame bracket 60.

When the body 100 rotates with the door D1, the cam 30 fixed to the body 100 rotates together. Since the height of the guide surface 31 formed on the upper part of the cam 30 changes by the direction of the circumference, the guide 40 contacting the guide surface 31 by the key 43 moves upward and downward according to the rotation of the cam 30.

Since the guide 40 is penetrated by the sliding part 12 of the shaft 10 not to rotate, the guide 40 moves upward and downward along the sliding part 12 regardless of rotation of the housing 20.

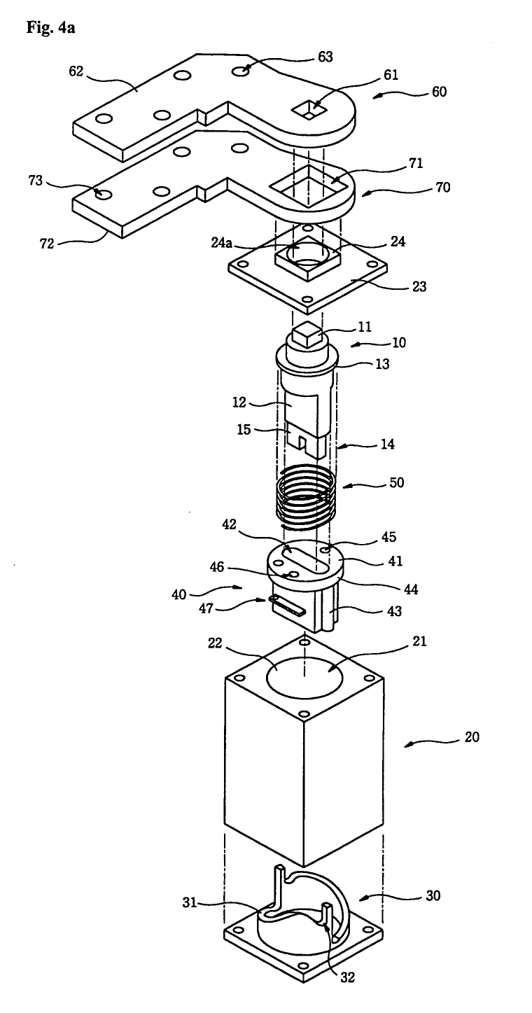

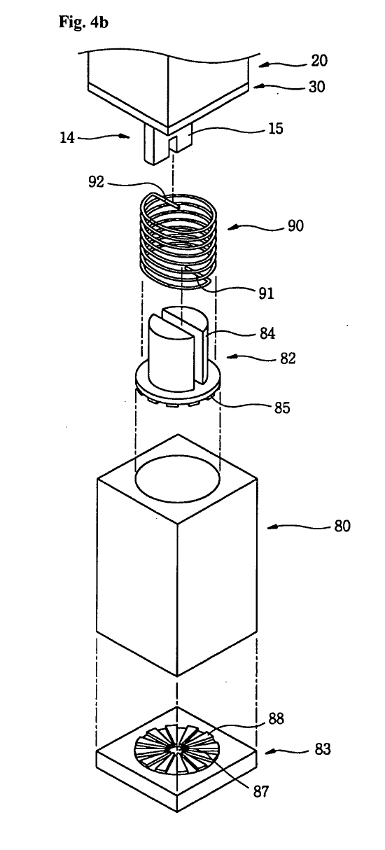

As the door D1 is opened, that is, when the door bracket 70 rotates counterclockwise in FIG. 4a, the guide 40 rises, and the viscous fluid contained in the upper compartment 20a moves to the lower compartment 20b through the first fluid passage 45. Also, the check valve plate 47 closing the second fluid passage 46 is opened by the viscous fluid flowed in through the second fluid passage 46 from the upper compartment 20a.

As the guide 40 rises, the compression spring 50 is compressed. Then, when the key 43 is caught by the key groove 32 formed on the guide surface 31, the opening of the door D1 and the rising of the guide 40 are stopped.

As the door D1 is opened, the cover 80 rotates around the shaft 10 together with the door D1. The torsion spring 90 is wound by the first arm 91 rotating with the cover 80 since the second arm 92 formed on the upper part of the torsion spring 90 is fixed to the shaft 10 by the connecting part 14, and the first arm 91 is fixed to the cover 80 by the control part 81.

As the door D1 is closed, that is, when the user pushes the door D1 clockwise, which is the direction closing the door D1, the key 43 caught by the key groove 32 formed on the guide surface 31 is separated from the key groove 32, and descends along the guide surface 31. Once the key 43 is separated from the key groove 32, the door D1 is closed automatically without any action of the user.

The guide 40 separated from the key groove 32 descends by the restoring force of the compression spring 50 compressed and the torsion spring 90 wound up. As the guide 40 descends, the viscous fluid contained in the lower compartment 20b flows into the upper compartment 20a through the first fluid passage 45. However, the check valve plate 47 is not opened when the guide 40 descends, differently from when it ascends, because the check valve plate 47 is set up on the lower surface of the circular plate 41. Therefore, the rotating velocity of the door D1 is relatively reduced by the resistance of the viscous fluid when the guide 40 descends rather than when the guide 40 ascends.

In the door-closing device according to a preferred embodiment of the present invention, the user can control the closing velocity of the door D1 from the outside. The wrench is inserted through the wrench hole 87 formed in the center of the fixed gear part 83 into the wrench groove 86 formed on the lower surface of the control plate 82 engaged with the fixed gear part 83. The engaged gears 88, 85 of the fixed gear part 83 and the control plate 82 are separated when the wrench is pushed upward, and when the wrench is removed after it is rotated to a desired direction, the gears 88, 85 of the fixed gear part 83 and the control plate 82 are engaged with each other and fixed by the compressing restoring force of the torsion spring 90, whereby the restoring force of the torsion spring 90 is controlled.

If the user winds the torsion spring 90 counterclockwise by the wrench to increase the restoring force, the closing velocity of the door D1 is increased. If the user winds the torsion spring 90 clockwise to decrease the restoring force, the closing velocity of the door D1 is decreased.

The above preferred embodiments of the present invention are disclosed as examples, and by changing the spring strength of the compression spring 50 and the torsion spring 90 or the design of the guide surface 31 of the cam 30, various door-closing types may be made: door types opened and closed to both directions, or stopped within a desired section, or possible to control the opening and closing velocity or set the maximum opening angle.

Also, a person skilled in the art will be able to make various changes, modifications, and additions within the scope and spirit of the present invention, and thus these changes, modifications, and additions should be regarded as belonging to the scope of protection of the appended claims below.

The door-closing device according to the present invention is effective for automatically closing the door by the restoring force generated from changing the rotation for opening the door into compression and torsion of the spring with using the cam, and controlling the closing velocity according to set-up conditions by making the user easily control the restoring force of the spring from the outside.

Also, this device is effective for changing the velocity of the door, stopping the rotation of the door, or controlling the frequency, at a desired angle by combinations of shapes of the cam or strengths of the spring.

In addition, this device is effectively applicable to various fields like household electric appliances and vehicles as well as the door, due to safe closing, easy opening, simple structure, and increased durability, when compared to conventional door-closing devices.

1. A door-closing device fixed to a door and door frame to close the door automatically, comprising:
a shaft having a fixed part formed on one end of the shaft and fixed to the door frame to prevent rotation, a sliding part whose outer circumferential surface is partly planar on the other end of the shaft, and a supporting part protruded on the outer circumferential surface of the shaft between the fixed part and the sliding part;
a housing fixed to the door, having a shaft hole formed on one end of the housing for the shaft to be inserted to the inside, wherein the inner part connected to the shaft hole is cylindrically spaced;
a cam fixed to the other end of the housing, having an annular guide surface protruded into the inner part of the housing;
a guide having a circular plate with a through hole of corresponding shape to the cross-section of the sliding part penetrating the through hole in the center of the circular plate, and a key protruded from the circular plate, moving along the guide surface of the cam, wherein the outer circumferential surface of the circular plate rectilinearly moves with contacting the surface of the inner part of the housing; and
a compression spring set up to wrap up the shaft between the supporting part of the shaft and the circular plate of the guide.

2. The door-closing device of claim 1, wherein the guide includes:
a first fluid passage and a second fluid passage penetrating the circular plate; and
a check valve plate for opening the second fluid passage by the flow of viscous fluid filled in the inner part of the housing when the compression spring is compressed, wherein one end of the check valve plate is fixed to the surface of the circular plate opposite to the cam, and the other end of the check valve plate is set up to close the second fluid passage.

3. The door-closing device of claim 1, further including:
a door frame bracket wherein the fixed part is inserted into a fixing hole formed on one end of the door frame bracket, and fixed, and the other end of the door frame bracket is fixed to the door frame; and
a door bracket wherein one end is fixed to the housing, and the other end is fixed to the door.

4. The door-closing device of claim 1, wherein the cam has upward parts and key grooves subsequently formed on the guide surface.

5. The door-closing device of claim 1, further including:
a connecting part extruded from the other end of the shaft to penetrate the center of the cam;
a cover fixed to the housing to contain the connecting part protruded to the outside of the housing in the inner part of the cover;
a control part set up inside of the cover to face the connecting part; and
a torsion spring of which each end is connected to the connecting part and the control part.

6. The door-closing device of claim 5, wherein the control part includes:
a fixed gear part fixed to the cover, with fixed gears arranged by the direction of the circumference around a wrench hole formed in the center of the fixed gear part; and
a control plate having the first two arm fixing parts protruded to form space fixing the first arm of the torsion spring on one surface of the control plate, and control plate gears corresponding to the fixed gears around a wrench groove formed in the center of the control plate on the other surface of the control plate, wherein the control plate gears are arranged by the direction of the circumference.

7. The door-closing device of claim 5, wherein the connecting part has the second two arm fixing parts protruded to form space fixing the second arm of the torsion spring.
